(19) United States
(12) Patent Application Publication
(10) Pub. No.: US 2002/0139341 A1
(43) Pub. Date: Oct. 3, 2002

(54) Recoil starter for engine of model

(75) Inventor: Eishi Tsuno, Tokyo (JP)

Correspondence Address: HOGAN & HARTSON L.L.P., 500 S. GRAND AVENUE, SUITE 1900, LOS ANGELES, CA, 90071-2611, US

(73) Assignee: SHUWA KOGYO KABUSHIKI KAISHA

(21) Appl. No.: 09/910,599

(22) Filed: Jul. 20, 2001

(30) Foreign Application Priority Data
Mar. 27, 2001 (JP) 2001-001633

(51) Int. Cl. F02N 1/00

(52) U.S. Cl. 123/185.3

(57) ABSTRACT

A recoil starter for an engine of a model includes a starter case and a spool rotatably accommodated within the starter case. A rope is wound around the spool and is connected to a handle. A recoil spring is accommodated within the starter case. The inner end of the recoil spring is engaged with a hook of the starter case, and the outer end of the recoil spring is engaged with an outer end portion of the spool. A one-way clutch assuming the form of a prism is fitted into a shaft hole formed in the spool and having a polygonal cross section to thereby be able to rotate unitarily with the spool. A starting shaft is rotatably supported by the starter case. The starting shaft has an extended portion which is inserted through the one-way clutch and penetrates the starter case. An attachment is attached to the extended portion of the starting shaft.

### BACKGROUND OF THE INVENTION

1. Field of the Invention

The present invention relates to a recoil starter for an engine of a model.

2. Description of the Related Art

A conventional recoil starter for an engine of a model is configured such that a starter rope is wound on a spool through utilization of restoration force of a recoil spring, as disclosed in, for example, Japanese Utility Model Registration No. 2516678. Specifically, a spool having a polygonal shaft hole formed therein is accommodated within a starter case. A cylindrical one-way clutch fitted to a crankshaft is press-fitted into a ratchet guide having the same polygonal shape as that of the shaft hole, to thereby form a ratchet assembly. The ratchet assembly is fitted into the shaft hole formed in the spool.

The recoil starter functions in the following manner. When a user pulls the starter rope, the spool rotates, and thus the ratchet assembly incorporated in the spool rotates. As result, the ratchet assembly enters an engaged state, so that the crankshaft penetrating the ratchet assembly is rotated. As a result, the engine of the model is started. When the crankshaft overruns the spool, the ratchet assembly enters a disengaged state. When the starter rope is released, the start rope is wound on the spool.

However, the conventional recoil starter involves the following problem. In an overchoked condition, such that excess fuel is contained within an engine, the user encounters difficulty in pulling the starter rope. As a result, the engine is unlikely to start.

In such a case, the user must remove a plug and empty fuel out of the engine. However, for a beginner who is unfamiliar with an engine of a model, such action is hard to carry out.

### SUMMARY OF THE INVENTION

In view of the foregoing fact, an object of the present invention is to provide a recoil starter for an engine of a model capable of starting the engine even when pulling of a starter rope is disabled with a resultant difficulty in starting the engine.

To achieve the above object, the present invention provides a recoil starter for an engine of a model which comprises a starter case and a spool rotatably accommodated within the starter case. A rope is wound around the spool and is connected to a handle. A recoil spring is accommodated within the starter case. The inner end of the recoil spring is engaged with a hook of the starter case, and the outer end of the recoil spring is engaged with an outer end portion of the spool. A one-way clutch assuming the form of a prism is fitted into a shaft hole formed in the spool and having a polygonal cross section to thereby be able to rotate unitarily with the spool. A starting shaft is rotatably supported by the starter case. The starting shaft has an extended portion which is inserted through the one-way clutch and penetrates the starter case. An attachment is attached to the extended portion of the starting shaft.

The above configuration enables a user to start the engine by use of a starter motor when the user encounters difficulty in starting the engine since the starter rope is hard to pull. In such a case, the user fits the attachment of the starter motor to the attachment of the recoil starter and starts the starter motor. Through this operation, the engine can be easily started.

Preferably, the attachment is a substantially conical rotary member.

Since the attachment of the recoil starter and that of the starter motor are in frictional contact, when an unusually large load is imposed on the attachments, they slide over each other to thereby prevent breakage of the engine and the starter motor.

Since the attachment of the recoil starter is a substantially conical rotary member, the attachment can be readily fitted to the rubber attachment of the starter motor. Thus, even a beginner who is unfamiliar with an engine of a model can selectively use either of the two engine-starting methods; startup of the engine by means of the recoil starter or startup by means of the starter motor.

The attachment may be a substantially cylindrical rotary member having a hemispherical recess opened to an end surface of said rotary member and at least one groove extending axially from the end surface.

Alternatively, the attachment may be a substantially cylindrical rotary member having a recess opened to an end surface of said rotary member and having a polygonal cross section.

### BRIEF DESCRIPTION OF THE DRAWINGS

FIG. 1 is an exploded perspective view showing a recoil starter according to an embodiment of the present invention and an engine of a model, to which the recoil starter is attached;

FIG. 2 is a plan view of the recoil starter of FIG. 1;

FIG. 3 is a sectional view taken along line III-III of FIG. 2;

FIG. 4 is a bottom view of the recoil starter of FIG. 2;

FIG. 5 is a sectional view of a recoil starter according to another embodiment of the present invention;

FIG. 6 is a sectional view of a recoil starter according to a further embodiment of the present invention, accompanied by perspective views of attachments;

FIG. 7 is a plan view of a recoil starter according to still another embodiment of the present invention;

FIG. 8 is a sectional view taken along line VIII-VIII of FIG. 7;

FIG. 9 is a perspective view of an attachment of a starter motor; and

FIG. 10 is a view viewed along the arrow X of FIG. 9.

### DESCRIPTION OF THE PREFERRED EMBODIMENTS

Embodiments of the present invention will next be described in detail with reference to the drawings.

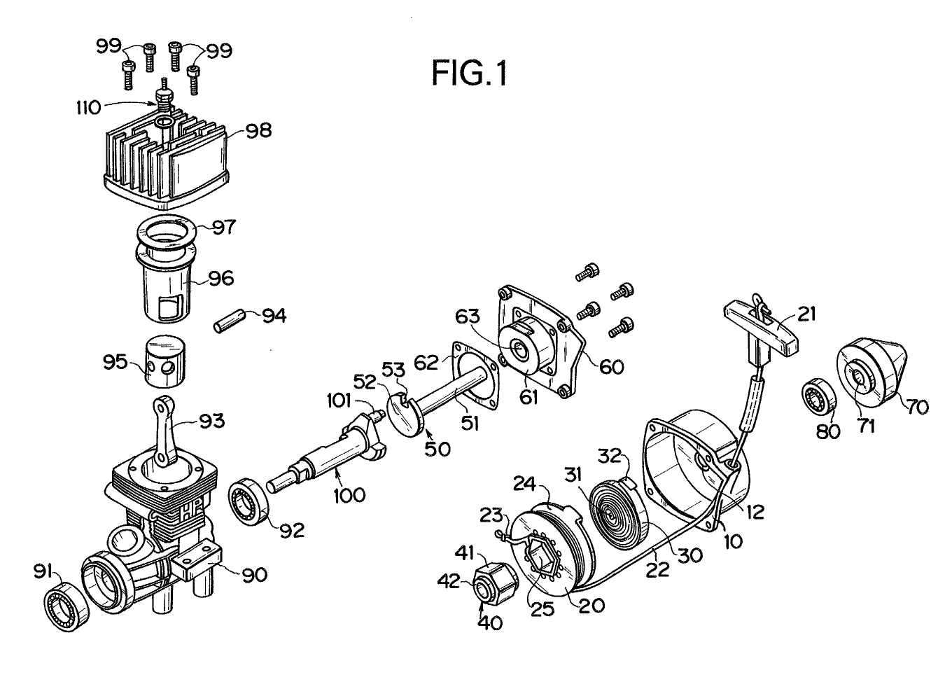

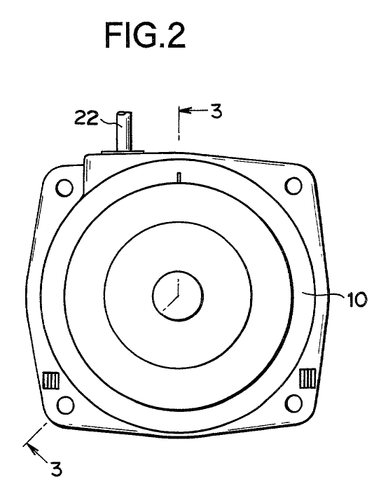

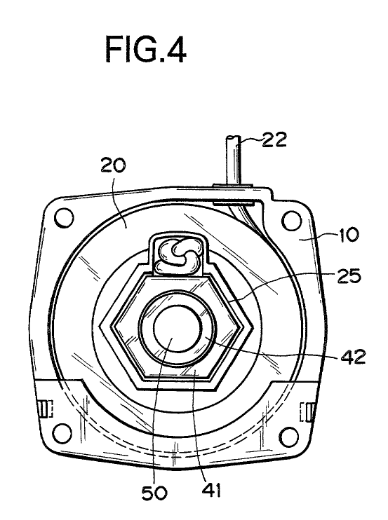

In FIGS. 1 to 4, reference numeral 10 denotes a starter case, which accommodates a spool 20 such that the spool 20 can rotate within the starter case 10. A rope 22 connected to a handle 21 is wound within a groove 24 formed along the circumference of the spool 20.

A recoil spring 30 is interposed between the spool 20 and the inner end face of the starter case 10. The recoil spring 30 is a spiral elastic spring of steel. An inner end 31 of the recoil spring 30 is hooked on a hook 11 of the starter case 10, whereas an outer end 32 is hooked on a peg 23 projecting from the outer end face of the spool 20.

A shaft hole 25 formed in the spool 20 has a polygonal cross section; in the present embodiment, a cross section of a regular hexagon. A one-way clutch 40 having the same polygonal cross section as that of the shaft hole 25 is fitted into the shaft hole 25 such that it can rotate unitarily with the spool 20. The one-way clutch 40 includes a polygonal clutch case 41 and a one-way bearing 42, which is press-fitted into the clutch case 41.

The starter case 10 accommodating the recoil spring 30, the spool 20, and the one-way clutch 40 is covered with a cover plate 60. The cover plate 60 has a bearing portion 61 and a gasket 62. A cylindrical dry metal 63 is fitted into the bearing portion 61 and adapted to rotatably support a starting shaft 50.

The starting shaft 50 is sequentially inserted into the dry metal 63 of the cover plate 60, the one-way clutch 40, the spool 20, the recoil spring 30, and a through-hole 12 formed in the starter case 10. An extended portion 51 of the starting shaft 30 which extends through the through-hole 12 is inserted through a bearing 80 fixedly attached to the outer end face of the starter case 10 and fitted into an attachment 70.

Thus, the starting shaft 50 is rotatably supported by the cover plate 60 and the starter case 10. Notably, the one-way clutch 40 is pressed-fitted onto the starting shaft 50 in such a manner that the one-way clutch 40 enters an engaged state when a user pulls the rope 22 in order to rotate the spool 20.

The attachment 70 is a substantially conical rotary member. The extended portion 51 of the starting shaft 50 is fitted into a shaft hole 71 formed in the attachment 70. The thus-fitted extended portion 51 is fixed by means of a hollow set screw 72 screwed into a threaded-hole 73 formed in the side wall of the attachment 70. The attachment 70 is fitted into a recess formed in a rubber attachment of a starter motor.

The starting shaft 50 includes a disc portion 52 provided at the end of an extended portion 51 opposite the end that fits into the attachment 70. A cut 53 is formed in the disc portion 52. A crankpin 101 of a crankshaft 100, which is rotatably supported on a crankcase 90 of an engine of a model product by means of bearings 91 and 92, is engaged with the cut 53.

While being engaged with the cut 53, the crankpin 101 is inserted through a connecting rod 93. The connecting rod 93 is connected to a piston 95 by means of a piston pin 94. The piston 95 reciprocates vertically within a cylinder 96, which is fitted into the crankcase 90.

A gasket 97 is disposed on an upper flange portion of the cylinder 96. A heat sink head 98 is fixedly mounted on an upper portion of the crankcase 90 by means of bolts 99. A glow plug 110 is attached to the heat sink head 98. The glow plug 110 ignites a compressed mixture within the cylinder 96.

In operation, a user holds the handle 21 and pulls the rope 22 against the recoil spring 30. The spool 20 rotates, and also the one-way clutch 40 incorporated in the spool 20 rotates. As a result, the one-way clutch 40 enters an engaged sate, so that the starting shaft 50 extending through the one-way clutch 40 is mechanically coupled to the spool 20. Thus, the starting shaft 50 is rotated. Rotation of the starting shaft 50 causes the crankshaft 100 to rotate, thereby starting the engine.

When startup of the engine causes the starting shaft 50 to overrun the spool 20, the one-way clutch 40 enters a disengaged state, so that the coupling between the spool 20 and the starting shaft 50 is broken. Subsequently, when the user releases the handle 21, the recoil spring 30 causes the spool 20 to rotate in reverse (at this time, the one-way clutch 40 rotates idle). As a result, the rope 22 is rewound within the groove 24 of the spool 20, thereby restoring the initial condition.

When the user encounters difficulty in pulling the rope 22 with a resultant failure to start the engine, the user fits the attachment of the starter motor to the attachment 70 and starts the starter motor. As a result, the starting shaft 50 rotates, and thus the crankshaft 100 engaged with the starting shaft 50 rotates, thereby starting the engine.

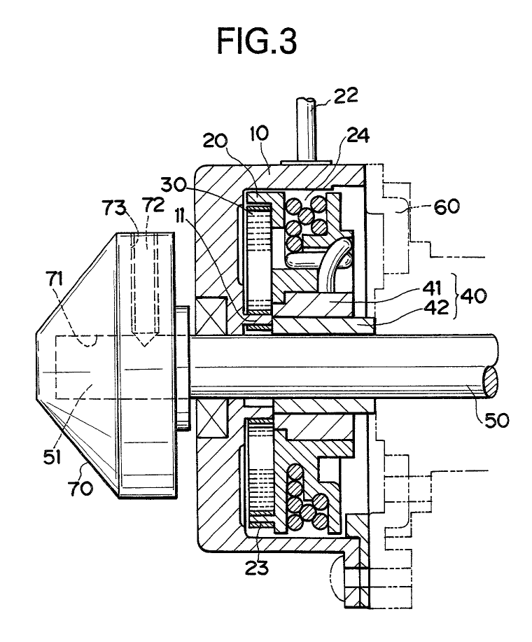

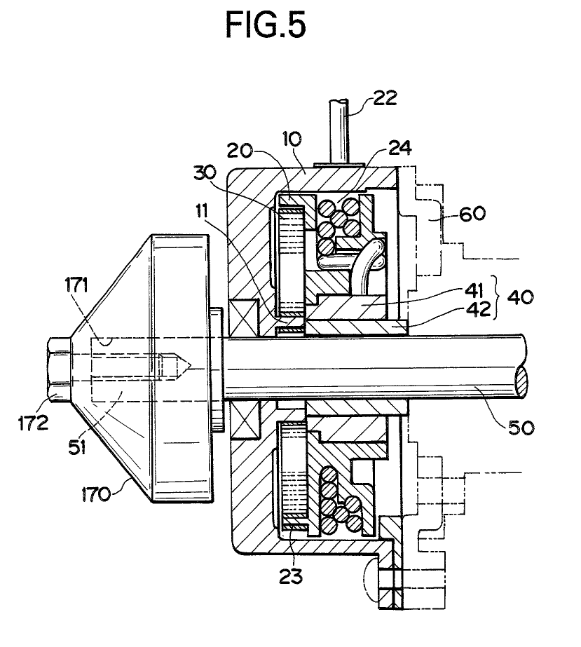

FIG. 5 is a sectional view of a recoil starter according to another embodiment of the present invention. As in the case of the embodiment of FIG. 3, an attachment 170 of the recoil starter is a substantially conical rotary member. The extended portion 51 of the starting shaft 50 is fitted into a shaft hole 171. The attachment 170 and the extended portion 51 of the starting shaft 50 are joined by means of a bolt 172, which is screwed into the extended portion 51 from the outwardly projecting end of the attachment 170.

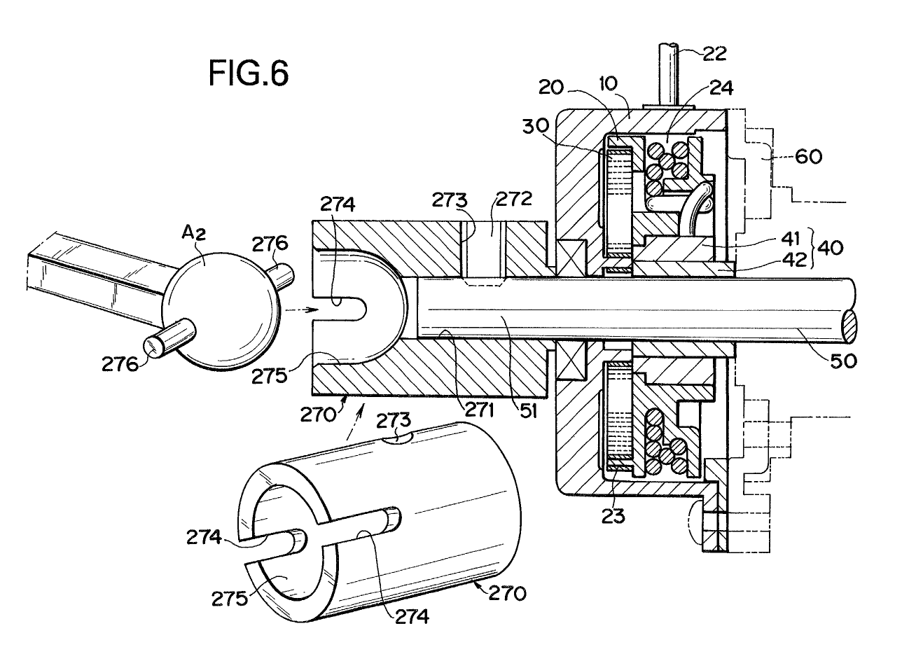

FIG. 6 is a sectional view of a recoil starter according to a further embodiment of the present invention. An attachment 270 of the recoil starter is a substantially cylindrical rotary member. The extended portion 51 of the starting shaft 50 is fitted into a shaft hole 271 formed in the attachment 270. The thus-fitted extended portion 51 is fixed by means of a hollow set screw 272 or a vis screwed into a threaded-hole 273 formed in the side wall of the attachment 270.

A pair of grooves 274 are formed in the wall of the attachment 270 at an outwardly projecting end portion thereof in an axially extending condition. A hemispherical recess 275 is formed at the outwardly projecting end portion of the attachment 270 in such a manner that the recess 275 is opened to the end surface of the attachment 270. A spherical attachment A₂ of a starter motor is fitted into the recess 275 while a pair of projecting rods 276 of the attachment A₂ are guided along the corresponding grooves 274.

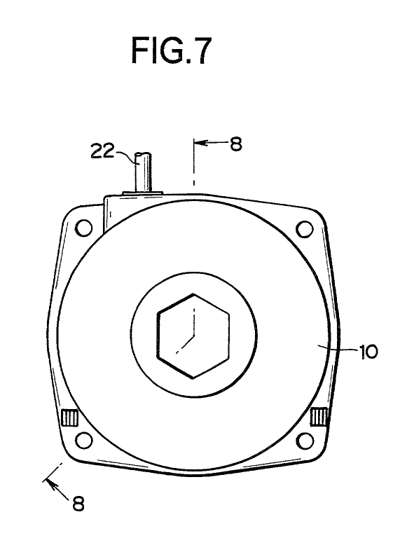

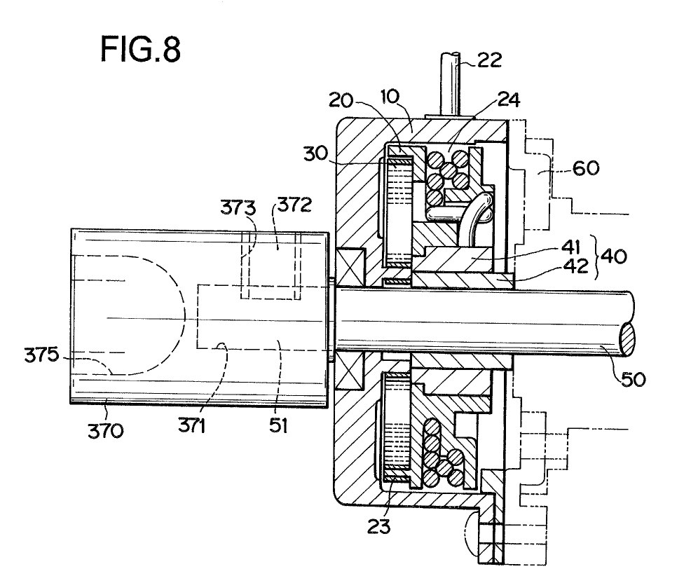

FIG. 7 is a plan view of a recoil starter according to still another embodiment of the present invention. FIG. 8 is a sectional view taken along line VIII-VIII of FIG. 7. An attachment 370 of the recoil starter is a substantially cylindrical rotary member. The extended portion 51 of the starting shaft 50 is fitted into a shaft hole 371 formed in the attachment 370. The thus-fitted extended portion 51 is fixed by means of a hollow set screw 372 or a vis screwed into a threaded-hole 373 formed in the side wall of the attachment 370.

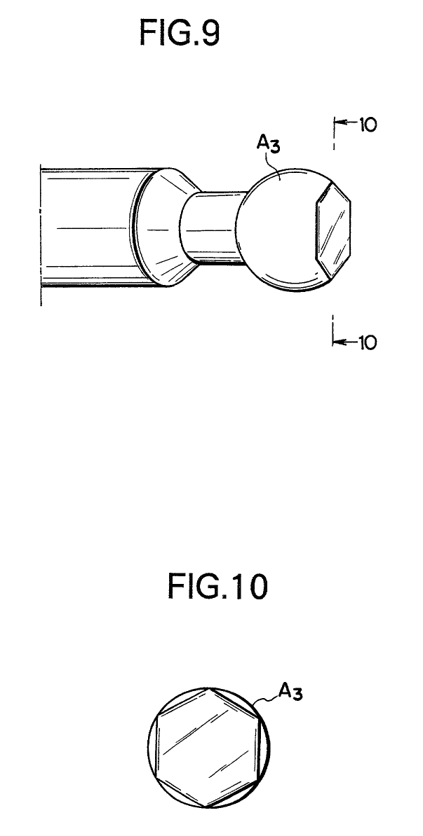

A recess 375 having a substantially hexagonal cross section is formed at the outwardly projecting end portion of the attachment 370 in such a manner that the recess 375 is opened to the end surface of the attachment 370. A rounded attachment A₃ having a substantially hexagonal cross section of a starter motor (see FIGS. 9 and 10) is fitted into the recess 375.

What is claimed is:

1. A recoil starter for an engine of a model, comprising:
a starter case;
a spool rotatably accommodated within said starter case;
a rope wound around said spool and connected to a handle;
a recoil spring accommodated within said starter case, said recoil spring having an inner end engaged with a hook of said starter case and an outer end engaged with an outer end portion of said spool;
a one-way clutch assuming the form of a prism, said one-way clutch being fitted into a shaft hole formed in said spool and having a polygonal cross section to thereby be able to rotate unitarily with said spool;
a starting shaft rotatably supported by said starter case and having an extended portion which is inserted through said one-way clutch and penetrates said starter case; and
an attachment attached to the extended portion of said starting shaft.

2. A recoil starter for an engine of a model according to claim 1, wherein said attachment is a substantially conical rotary member.

3. A recoil starter for an engine of a model according to claim 1, wherein said attachment is a substantially cylindrical rotary member having a hemispherical recess opened to an end surface of said rotary member and at least one groove extending axially from the end surface.

4. A recoil starter for an engine of a model according to claim 1, wherein said attachment is a substantially cylindrical rotary member having a recess opened to an end surface of said rotary member and having a polygonal cross section.
